(19) United States
(12) Patent Application Publication
(10) Pub. No.: US 2023/0284768 A1
(43) Pub. Date: Sep. 14, 2023

(54) BEAUTY MAKEUP SPECIAL EFFECT GENERATION METHOD, DEVICE, AND STORAGE MEDIUM

(71) Applicant: Beijing Zitiao Network Technology Co., Ltd., Beijing (CN)

(72) Inventors: Kewei CHEN, Beijing (CN); Shizeng YAN, Beijing (CN); Qiuhan HUANG, Beijing (CN)

(21) Appl. No.: 18/059,793

(22) Filed: Nov. 29, 2022

(30) Foreign Application Priority Data
Mar. 11, 2022 (CN) 202210239393.6

(51) Int. Cl. A45D 44/00; G06T 11/00; G06T 17/20; G06T 3/40

(52) U.S. Cl. CPC A45D 44/005; G06T 11/001; G06T 17/20; G06T 3/40

(57) ABSTRACT

A beauty makeup special effect generation method, a beauty makeup special effect generation apparatus, a device, a storage medium, and a program product are provided. The method includes receiving a color adjustment operation for a first beauty makeup special effect; determining a target color corresponding to the color adjustment operation in response to the color adjustment operation, and performing color adjustment on the first beauty makeup special effect according to the target color to generate a second beauty makeup special effect.

### CROSS-REFERENCE TO RELATED APPLICATION

This application claims priority to Chinese Patent Application No. CN202210239393.6, filed on Mar. 11, 2022, the disclosure of which is incorporated herein by reference in its entirety.

### TECHNICAL FIELD

Embodiments of the present disclosure relate to the field of computer technology, and more particularly, to a beauty makeup special effect generation method and apparatus, a device, a storage medium, and a program product.

### BACKGROUND

Currently, when creating a beauty makeup special effect, a creator is required to draw a beauty makeup material on a reference model figure and import the beauty material into a special effect creating tool for special effect creating. However, this beauty makeup special effect creating method is cumbersome in operation and has a high difficulty, resulting in a low beauty makeup special effect creating efficiency.

### SUMMARY

A beauty makeup special effect creating method and apparatus, a device, a storage medium, and a program product are provided according to embodiments of the present disclosure to simplify the operation required for creating a beauty makeup special effect and reduce the difficulty in creating the beauty makeup special effect.

In a first aspect, a beauty makeup special effect generation method is provided according to embodiments of the present disclosure, and the method includes:
receiving a color adjustment operation for a first beauty makeup special effect; and
determining a target color corresponding to the color adjustment operation in response to the color adjustment operation, and performing color adjustment on the first beauty makeup special effect according to the target color to generate a second beauty makeup special effect.

In a second aspect, a beauty makeup special effect generation apparatus is further provided according to embodiments of the present disclosure, which includes: an operation receiving module and a color adjustment module.

The operation receiving module is configured to receive a color adjustment operation for a first beauty makeup special effect.

The color adjustment module is configured to, in response to the color adjustment operation, determine a target color corresponding to the color adjustment operation, and perform color adjustment on the first beauty makeup special effect according to a target color to generate a second beauty makeup special effect.

In a third aspect, an electronic device is further provided according to embodiments of the present disclosure, which includes:
one or more processors; and
a memory configured to store one or more programs,
the one or more programs, when executed by the one or more processors, cause the one or more processors to implement the beauty makeup special effect generation method according to any embodiment of the present disclosure.

In a fourth aspect, a computer-readable storage medium is further provided according to an embodiment of the present disclosure, in which a computer program is stored. The program, when executed by a processor, implements the beauty makeup special effect generation method according to any embodiment of the present disclosure.

In a fifth aspect, a computer program product is further provided according to an embodiment of the present disclosure, the computer program product, when executed by a computer, causes the computer to implement the beauty makeup special effect generation method according to any embodiment of the present disclosure.

With the beauty makeup special effect generation method, the beauty makeup special effect generation apparatus, the device, the storage medium, and the program product according to the embodiments of the present disclosure, a color adjustment operation for a first beauty makeup special effect is received; and a target color corresponding to the color adjustment operation in response to the color adjustment operation is determined, and color adjustment is performed on the first beauty makeup special effect according to the target color to generate a second beauty makeup special effect. According to the embodiments of the present disclosure, by using the above-mentioned technical solution, adjustment is performed directly on the basis of the first beauty makeup special effect to obtain the second beauty makeup special effect without redrawing the beauty makeup special effect material, so that the difficulty in creating the beauty makeup special effect can be lowered, the efficiency of creating the beauty makeup special effect can be improved, and the user experience can be improved.

### BRIEF DESCRIPTION OF DRAWINGS

The above and other features, advantages, and aspects of embodiments of the present disclosure will become more apparent in conjunction with the drawings and with reference to embodiments. Same or similar reference numerals through the drawings denote same or similar elements. It is to be understood that the drawings are illustrative and that originals and elements are not necessarily drawn to scale.

FIG. 1 is a flowchart of a beauty makeup special effect generation method according to an embodiment of the present disclosure;

FIG. 2 is a flowchart of another beauty makeup special effect generation method according to an embodiment of the present disclosure;

FIG. 3 is a structural block diagram of a beauty makeup special effect generation apparatus according to an embodiment of the present disclosure;

FIG. 4 is a schematic structural diagram of an electronic device according to an embodiment of the present disclosure.

### DETAILED DESCRIPTION

Embodiments of the present disclosure are described in more detail hereinafter with reference to the drawings. Although some embodiments of the present disclosure are shown in the drawings, it is to be understood that the present disclosure may be implemented in various forms and should not be construed as limited to the embodiments set forth herein; conversely, these embodiments are provided in order for the present disclosure to be thoroughly and completely understood. It should be understood that drawings and embodiments of the present disclosure are merely illustrative and are not intended to limit the scope of the present disclosure.

It is to be understood that the various steps set forth in the method embodiments of the present disclosure may be performed in a different order, and/or in parallel. In addition, the method embodiments may include additional steps and/or omit performing the illustrated steps. The scope of the present disclosure is not limited in this respect.

As used herein, the term “include” and variations thereof are intended to be inclusive, that is, “including, but not limited to”. The term “based on” is “at least partially based on”. The term “one embodiment” means “at least one embodiment”; the term “another embodiment” means “at least another embodiment”; and the term “some embodiments” means “at least some embodiments”. Related definitions of other terms are given in the description hereinafter.

It is to be noted that references to “first”, “second” and the like in the present disclosure are merely intended to distinguish one from another apparatus, module, or unit and are not intended to define the order or interrelationship of the functions performed by the apparatus, module, or unit.

It is to be noted that references to modifications of “one” or “more/a plurality/multiple” mentioned in the present disclosure are intended to be illustrative rather than limiting; the person skilled in the art should understand that “one” or “more/a plurality/multiple” should be understood as “one or more” unless clearly indicated in the context.

The names of messages or information exchanged between multiple apparatuses in embodiments of the present disclosure are only for illustrative purposes rather than being intended to limit the scope of such messages or information.

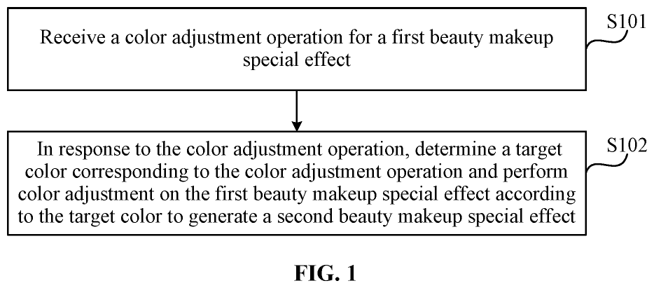

FIG. 1 is a flowchart of a beauty makeup special effect generation method according to an embodiment of the present disclosure. The method may be performed by a beauty makeup special effect generation apparatus, where the device may be implemented by software and/or hardware, may be configured in an electronic device, and typically may be configured in a mobile phone or a tablet computer. The beauty makeup special effect generation method provided in the embodiment of the present disclosure is applicable to a scene in which a special effect is created, and is particularly applicable to a scene in which a new special effect is created on the basis of an existing special effect. As shown in FIG. 1, the beauty makeup special effect generation method according to this embodiment may include: S101 and S102.

S101 may include receiving a color adjustment operation for a first beauty makeup special effect.

For example, the first beauty makeup special effect may be a created beauty makeup special effect, which may be a issued beauty makeup special effect or an unissued beauty makeup special effect, and the first beauty makeup special effect may be, for example, a video special effect, such as a beauty makeup special effect applied in a video. Accordingly, the color adjustment operation may be an operation that adjusts the color of a certain beauty makeup special effect (i.e., the first beauty makeup special effect), such as an operation that selects a color in a special effect adjustment page of the first beauty makeup special effect. The color adjustment operation may be performed by a special effect user or a special effect creator, for example, the user, in the process of using a beauty makeup special effect (such as the first beauty makeup special effect), may adjust the color of the beauty makeup special effect by performing the color adjustment operation, and process a video with the new beauty makeup special effect obtained through the adjustment. Alternatively, after completing the creation of a certain beauty makeup special effect (such as the first beauty makeup special effect), the user may further adjust the color of the beauty makeup special effect by performing the color adjustment operation to obtain a new beauty makeup special effect.

For example, when a user (e.g., a special effect user and/or a special effect creator, etc.) is intended to adjust the color of the first beauty makeup special effect, the user may perform a color adjustment operation for a first beauty makeup special effect, for example, switching to a special effect adjustment page for the first beauty makeup special effect, and selecting a color in the special effect adjustment page to be used for color adjustment of the first beauty makeup special effect. Accordingly, the electronic device can receive the color adjustment operation performed by the user.

S102 may include, determining, in response to the color adjustment operation, a target color corresponding to the color adjustment operation, and performing color adjustment on the first beauty makeup special effect according to the target color, to generate a second beauty makeup special effect.

The target color may be a color corresponding to the color adjustment operation, such as a color selected by the user through the color adjustment operation. The second beauty makeup special effect may be a new beauty makeup special effect obtained by creating on the basis of the first beauty makeup special effect by the user, such as a new beauty makeup special effect obtained by performing color adjustment and/or position adjustment on the first beauty makeup special effect.

For example, the electronic device, when receiving the color adjustment operation for the first beauty makeup special effect, may determine a target color selected by the user, and perform color adjustment on the first beauty makeup special effect according to the target color. For example, the electronic device may determine, according to color information of the target color and initial color information of each of the pixels in the first beauty makeup special effect, information of the target color to which the corresponding pixels need to be adjusted, and perform color adjustment on the pixels on the basis of the information of the target color of the pixels. Therefore, after the adjustment is completed, the user may instruct, by performing a special effect generation operation, the electronic device to generate a second beauty makeup special effect, to issue the second beauty makeup special effect or perform video processing by using the second beauty makeup special effect.

In addition, when the user adjusts the first beauty makeup special effect, the electronic device may display a preview effect of the adjusted first beauty makeup special effect in real time, for example, the electronic device may use in real time the adjusted first beauty makeup special effect to process a preset image or an image acquired in real time by a camera, and display a preview image obtained by the processing for a user to view.

In this embodiment, a user can adjust a beauty makeup special effect which has been completely created, for example, the user can re-import the beauty makeup special effect into the special effect creating tool to adjust the beauty makeup special effect before or after the beauty makeup special effect is issued, without requiring to re-draw the beauty makeup special effect material for multiple times and import the beauty makeup special effect material into the special effect creating tool to view the effect and create the special effect. Compared with the technical solution in which, after the beauty makeup special effect material is drawn and is imported into the special effect creating tool and the effect is viewed, if the effect of the beauty makeup special effect is not satisfying, it is required to re-draw the beauty makeup special effect material and import the redrawn beauty makeup special effect into the special effect creating tool to view the effect, the technical solution according to this embodiment can lower the difficulty in creating the beauty makeup special effect, improve the efficiency in creating the special effect, and improve the user experience.

In one embodiment, the performing color adjustment on the first beauty makeup special effect according to the target color may include for at least part of color components of at least part of pixels in the first beauty makeup special effect, determining a current adjustment coefficient corresponding to a current color component according to the target color; and adjusting a color component value of the current color component by using the current adjustment coefficient and a current transparency coefficient of the first beauty makeup special effect. Therefore, when performing color adjustment, the target color and the original color of the beauty makeup special effect can be comprehensively considered, and the color adjustment effect of the beauty makeup special effect can be improved.

Here, the current color component may be a color component on which color adjustment is currently performed, that is, a color component of a current pixel whose adjustment coefficient needs to be determined currently, such as a red color component, a green color component, or a blue color component of the current pixel. The current adjustment coefficient may be an adjustment coefficient of the current color component. The current transparency coefficient may be a transparency coefficient of the first beauty makeup special effect at the current moment, which may be an initial transparency coefficient of the first beauty makeup special effect; and may also be a transparency coefficient of the first beauty makeup special effect after being adjusted by the user, that is, the user can adjust the transparency coefficient of the first beauty makeup special effect by performing a transparency coefficient adjustment operation.

Illustratively, when performing color adjustment on the first beauty makeup special effect, for at least part of pixels in the first beauty makeup special effect, it is feasible to first determine an adjustment coefficient corresponding to a corresponding color component according to the target color and a color component value of the pixel in each of the at least part of the color channels; and then, determine, according to the adjustment coefficient and a current transparency coefficient of the first beauty makeup special effect, a target color component value to which a corresponding color channel is required to be adjusted, and adjust the color of the pixel according to the target color component value.

for example, each color component value of each pixel in the first beauty makeup special effect may be adjusted. In this case, assuming that initial color component values of the pixel in the color channels before adjustment are (r₀, g₀, b₀), a current transparency coefficient of the first beauty makeup special effect is G₀, and determined adjustment coefficients corresponding to the color components of the pixel are (cᵣ, c_{g}, c_{b}), target color component values to which the pixel is required to be adjusted in the color channels may be (r₀cᵣG₀, g₀c_{g}G₀, b₀c_{b}G₀).

In one embodiment, the user may also adjust a position where the first beauty makeup special effect is added, and accordingly, when the first beauty makeup special effect is a human image beauty makeup special effect, the method further includes adjusting a position, where the first beauty makeup special effect is added, in a corresponding human image part in response to a position adjustment operation for the first beauty makeup special effect.

For example, the human image beauty makeup special effect may be understood as a beauty makeup special effect added to a character image in an image, such as a beauty makeup special effect applied to a human face or a human body, and the following description is given by taking the beauty makeup special effect applied to a human face as an example. Accordingly, the human image part may be a human face part or a human body part. The position adjustment operation may be an operation that adjusts the position of the first beauty makeup special effect relative to a human image part corresponding to the first beauty makeup special effect, such as a drag operation acting on the first beauty makeup special effect or a position scaling operation for the first beauty makeup special effect.

Illustratively, when intended to adjust a position where the first beauty makeup special effect is added, the user may perform a position adjustment operation for the first beauty makeup special effect, such as performing a drag operation or a scaling coefficient adjustment operation for the first beauty makeup special effect. Thus, when the electronic device receives the position adjustment operation from the user, it can determine, according to the position adjustment operation, a target position to which the first beauty makeup special effect is required to be adjusted as the position where the first beauty makeup special effect is to be added, and add the first beauty makeup special effect at the position where the first beauty makeup special effect is to be added so that the user can view a preview effect of the adjusted first beauty makeup special effect.

In the above-described embodiment, the position where the first beauty makeup special effect is added can be adjusted by the user through the position adjustment operation. For example, when the position where the first beauty makeup special effect is added deviates from a display position of the corresponding human image part, the first beauty makeup special effect can be adjusted to be aligned with the display position of the corresponding human image part, or when the position where the first beauty makeup special effect is added is aligned with the display position of the corresponding human image part, the first beauty makeup special effect can be adjusted to be misaligned with the display position of the corresponding human image part, without requiring to redraw the beauty makeup special effect material and import the beauty makeup special effect material into the special effect creating tool to view the effect for multiple times and create the beauty makeup special effect. Therefore, it is possible not only to simplify the creating of the beauty makeup special effect and improve the efficiency in creating the beauty makeup special effect; but also to meet the personalized requirements of different users and improve the user experience.

In one embodiment, the adjusting a position where the first beauty makeup special effect is added in a corresponding human image part includes adjusting key points corresponding to the first beauty makeup special effect in a corresponding human image part; and determining a position where the first beauty makeup special effect is to be moved according to the key points adjusted.

For example, the key points, corresponding to the first beauty makeup special effect, in the corresponding human image part can be understood as key points for positioning the first beauty makeup special effect when the first beauty makeup special effect is added at the corresponding human image part, that is, the position where the first beauty makeup special effect is to be added can be determined according to the key points, corresponding to the first beauty makeup special effect, in the corresponding human image part. Therefore, in this embodiment, the position where the first beauty makeup special effect is added in the human image part can be adjusted by adjusting the key points, corresponding to the first beauty makeup special effect, in the corresponding human image part.

Illustratively, the relative position of the first beauty makeup special effect to the corresponding human image part may be adjusted according to the position adjustment operation, key points, corresponding to the adjusted first beauty makeup special effect, in the corresponding human image part are determined according to the relative position, and the position where the first beauty makeup special effect is to be moved is determined according to the positions of the key points. For example, when a video is processed with the adjusted first beauty makeup special effect, the corresponding key points in the character image displayed in the video may be identified, and the adjusted first beauty makeup special effect may be added to the position corresponding to the corresponding key points. Therefore, the position where the beauty makeup special effect is added is adjusted, and the personalized requirement of a user is met.

In the beauty makeup special effect generation method according to this embodiment, a color adjustment operation for a first beauty makeup special effect is received; and a target color corresponding to the color adjustment operation in response to the color adjustment operation is determined, and color adjustment is performed on the first beauty makeup special effect according to the target color to generate a second beauty makeup special effect. According to this embodiment, by taking the above-described technical solution, the second beauty makeup special effect is obtained by a direct adjustment on the basis of the first beauty makeup special effect without requiring to redraw the beauty makeup special effect material, so that the difficulty in creating the beauty makeup special effect can be lowered, the efficiency for creating the beauty makeup special effect can be improved, and the user experience can be improved.

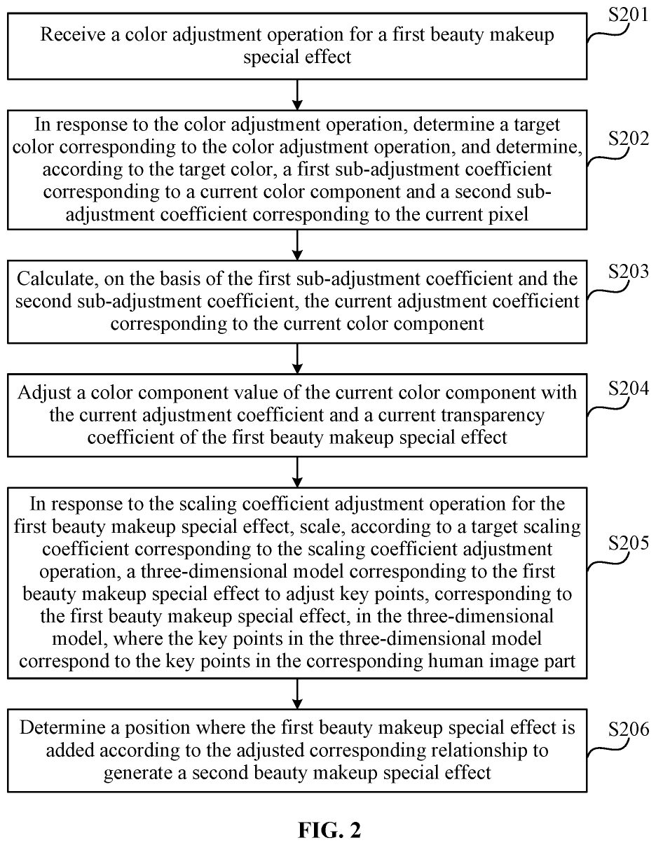

FIG. 2 is a flowchart of another beauty makeup special effect generation method according to an embodiment of the present disclosure. The solution in this embodiment may be combined with one or more optional embodiments in the above embodiments. Optionally, the determining a current adjustment coefficient corresponding to a current color component according to the target color includes determining the first sub-adjustment coefficient corresponding to the current color component and the second sub-adjustment coefficient corresponding to the current pixel according to the target color; and calculating, on the basis of the first sub-adjustment coefficient and the second sub-adjustment coefficient, a current adjustment coefficient corresponding to the current color component.

Optionally, the position adjustment operation is a scaling coefficient adjustment operation, and the adjusting key points, corresponding to the first beauty makeup special effect, in a corresponding human image part includes scaling, according to a target scaling coefficient corresponding to the scaling coefficient adjustment operation, a three-dimensional model corresponding to the first beauty makeup special effect to adjust key points corresponding to the first beauty makeup special effect in the three-dimensional model, where the key points in the three-dimensional model correspond to the key points in the corresponding human image part.

Accordingly, as shown in FIG. 2, the beauty makeup special effect generation method according to this embodiment may include: S201, S202, S203, S204, S205 and S206.

S201 may include receiving a color adjustment operation for a first beauty makeup special effect.

S202 may include, in response to the color adjustment operation, determining a target color corresponding to the color adjustment operation, and determining, according to the target color, a first sub-adjustment coefficient corresponding to a current color component and a second sub-adjustment coefficient corresponding to the current pixel.

For example, the first sub-adjustment coefficient may be a sub-adjustment coefficient corresponding to a current color component of the current pixel, and may correspond to only the current color component. The second sub-adjustment coefficient may be a sub-adjustment coefficient corresponding to the current pixel, and may correspond to color components of the current pixel (i.e., a red color component, a green color component, and a blue color component of the current pixel), that is, the color components of the current pixel may share one second sub-adjustment coefficient.

Illustratively, the first sub-adjustment coefficient corresponding to a current color component may be determined according to a color component value of a corresponding color component, which corresponds to the current color component, in the target color, and the second sub-adjustment coefficient corresponding to the current pixel may be obtained by calculating according to a grayscale value corresponding to the target color or an average value or mid-value of the color component values of the target color.

In one embodiment, the determining, according to the target color, a first sub-adjustment coefficient corresponding to a current color component and a second sub-adjustment coefficient corresponding to the current pixel may include determining the first sub-adjustment coefficient corresponding to the current color component according to a color component value of a corresponding color component, corresponding to the current color component, in the target color; and determining the second sub-adjustment coefficient corresponding to the current pixel according to a first grayscale value of a target pixel, which corresponds to the current pixel, in a target grayscale image and a second grayscale value corresponding to the target color, for example, pixels in the target grayscale image correspond to pixels in the first beauty makeup special effect.

The target grayscale image may be a grayscale image for performing color adjustment on the first beauty makeup special effect, and may be set by a creator or a user of the first beauty makeup special effect. The pixels in the target grayscale image correspond to the pixels in the first beauty makeup special effect, and may be in one-to-one correspondence with the pixels in the first beauty makeup special effect, so as to implement color adjustment pixel by pixel for the first beauty makeup special effect. Accordingly, the target pixel may be a pixel, corresponding to the current pixel in the first beauty makeup special effect, in the target grayscale image. The first grayscale value may be a grayscale value of the target pixel. The second grayscale value may be a grayscale value corresponding to the target color, that is, a grayscale value obtained by performing grayscale processing on the target color.

Illustratively, when determining the first sub-adjustment coefficient, the color component value of the corresponding color component of the target color can be normalized to obtain the first sub-adjustment coefficient of the current color component. For example, assuming that color component values of the target color in a red color channel, a green color channel, and a blue color channel are (r₁, g₁, b₁), thus, when a current color component is a red color component, the first sub-adjustment coefficient corresponding to the current color component is r₁/255; when a current color component is a green color component, the first sub-adjustment coefficient corresponding to the current color component is g₁/255; and when a current color component is a blue color component, the first sub-adjustment coefficient corresponding to the current color component is b₁/255.

When determining the second sub-adjustment coefficient, the first grayscale value and the second grayscale value may be normalized, respectively, and the product of the first grayscale value normalized and the second grayscale value normalized may be used as the second sub-adjustment coefficient corresponding to the current pixel. For example, assuming that a first grayscale value of the target pixel, corresponding to the current pixel, in the target grayscale image is G₀ and the second grayscale value corresponding to the target color is G₁, the second sub-adjustment coefficient corresponding to the current pixel is (G₀/255)×(G₁/255).

In this embodiment, the color of the beauty makeup special effect can be further adjusted pixel by pixel by means of the grayscale image to achieve special effects such as local weakening, local enhancement and/or shadowing, thereby meeting different requirements of the user on the premise of improving the creation efficiency of the beauty makeup special effect, improving the visual effect presented by the beauty makeup special effect, and improving the user experience.

S203 may include calculating, on the basis of the first sub-adjustment coefficient and the second sub-adjustment coefficient, the current adjustment coefficient corresponding to the current color component.

Illustratively, after the first sub-adjustment coefficient corresponding to the current color component of the current pixel and the second sub-adjustment coefficient corresponding to the current pixel are obtained, the product of the first sub-adjustment coefficient and the second sub-adjustment coefficient can be calculated as the current adjustment coefficient corresponding to the current color component of the current pixel.

It may be appreciated that in a case where the first beauty makeup special effect does not have a corresponding target grayscale image, color adjustment may be performed on the first beauty makeup special effect on the basis of only the first sub-adjustment coefficient, that is, the first sub-adjustment coefficient corresponding to the current color component of the current pixel may be directly used as the current adjustment coefficient of the current color component of the current pixel. In a case where the first beauty makeup special effect has a corresponding target grayscale image, it may also determine the second sub-adjustment coefficient corresponding to the current pixel on the basis of only the target grayscale image, for example, the second sub-adjustment coefficient corresponding to the current pixel may be determined according to the grayscale value of the target pixel, corresponding to the current pixel, in the target grayscale image, which is not limited in this embodiment.

S204 may include adjusting a color component value of the current color component by using the current adjustment coefficient and a current transparency coefficient of the first beauty makeup special effect.

For example, assuming that initial color component values of the current pixel in the red color channel, the green color channel, and the blue color channel before adjustment are (r₀, g₀, b₀), a grayscale value of the pixel, corresponding to the current pixel, in a target grayscale image is G₀, color component values of the target color in the color channels are (r₁, g₁, b₁), a grayscale value corresponding to the target color is G₁, a current transparency coefficient of the first beauty makeup special effect is c₀, and assuming that the determined adjustment coefficient corresponding to the color components of the current pixel are (cᵣ, c_{g}, c_{b}), and target color component values to which the current pixel is required to be adjusted in the color channels are (r₂, g₂, b₂), it can be obtained that

cᵣ=(r₁/255)×(G₀/255)×(G₁/255);

c_{g}=(g₁/255)×(G₀/255)×(G₁/255);

c_{b}=(b₁/255)×(G₀/255)×(G₁/255); and

the target color component values to which the current pixel is required to be adjusted in the color channels are respectively:

r₂=r₀cᵣG₀=r₀×(r₁/255)×(G₀/255)×(G₁/255)×G₀;

g₂=g₀c_{g}G₀=g₀×(g₁/255)×(G₀/255)×(G₁/255)×G₀;

b₂=b₀c_{b}G₀=b₀×(b₁/255)×(G₀/255)×(G₁/255)×G₀.

S205 may include, in response to the scaling coefficient adjustment operation for the first beauty makeup special effect, scaling, according to a target scaling coefficient corresponding to the scaling coefficient adjustment operation, a three-dimensional model corresponding to the first beauty makeup special effect to adjust key points, corresponding to the first beauty makeup special effect, in the three-dimensional model, where the key points in the three-dimensional model correspond to the key points in the corresponding human image part.

The three-dimensional model corresponding to the first beauty makeup special effect may be a model used for mapping and rendering the first beauty makeup special effect. The three-dimensional model may be obtained by performing key point recognition by using a preset key point recognition algorithm and meshing by using the key points which are obtained by the recognition and used as mesh vertexes. The key point recognition algorithm may be the same as the key point recognition algorithm used for recognizing the key points of the corresponding human image part, and may also be the same as the key point recognition algorithm used for recognizing the key points of the reference model image when the creator of the first beauty makeup special effect draws the special effect material of the first beauty makeup special effect. The key points in the three-dimensional model may be the mesh vertexes of the three-dimensional model. The scaling coefficient adjustment operation may be an operation that adjusts the scaling coefficient of the first beauty makeup special effect. Accordingly, the target scaling coefficient is a scaling coefficient to which the scaling coefficient is adjusted by the scaling coefficient adjustment operation.

In this embodiment, the key points corresponding to the first beauty makeup special effect in the three-dimensional model can be adjusted by scaling the three-dimensional model corresponding to the first beauty makeup special effect, and further the key points corresponding to the first beauty makeup special effect in the corresponding human image part can be adjusted, that is, the meshes covered by the first beauty makeup special effect in the three-dimensional model can be adjusted by scaling the three-dimensional model, and further the position where the first beauty makeup special effect is added in the corresponding human image part can be adjusted.

Illustratively, the three-dimensional model may be scaled with a preset point (e.g., a point at the center of the three-dimensional model or a certain point at the boundary of the three-dimensional model, etc.) as the origin and according to the target scaling coefficient to which the scaling coefficient is adjusted by the scaling coefficient adjustment operation. For each mesh vertex in the three-dimensional model, assuming that the coordinates of the mesh vertex are (vₓ, v_{y}), the coordinates of the origin are (vₓ₀, v_{y0}), and the coordinates of the target scaling coefficient is (sₓ, s_{y}), the coordinates of the mesh vertex after being scaled are ([(vₓ−vₓ₀)×sₓ]+vₓ₀, [(v_{y}−v_{y0})×s_{y}]+v_{y0}).

S206 may include determining a position where the first beauty makeup special effect is added according to the adjusted corresponding relationship to generate a second beauty makeup special effect.

It should be noted that the above-described order of responding to the color adjustment operation and the scaling coefficient adjustment operation is merely exemplary description, and does not limit the performing order of the steps. For example, the user may first execute the scaling coefficient adjustment operation and then execute the color adjustment operation, or execute multiple times of color adjustment operations and multiple times of scaling coefficient adjustment operations alternately. In this case, the electronic device may respond to trigger operations according to the order of the trigger operations executed by the user, thereby finally obtaining the second beauty makeup special effect.

According to the beauty makeup special effect generation method provided in this embodiment, the color adjustment is performed on the first beauty makeup special effect according to the first sub-adjustment coefficient and the second sub-adjustment coefficient, and the position where the first beauty makeup special effect is added is adjusted by scaling the three-dimensional model corresponding to the first beauty makeup special effect, so that not only the creation efficiency of the beauty makeup special effect can be improved; but also different requirements of the user can be met and the user experience can be improved.

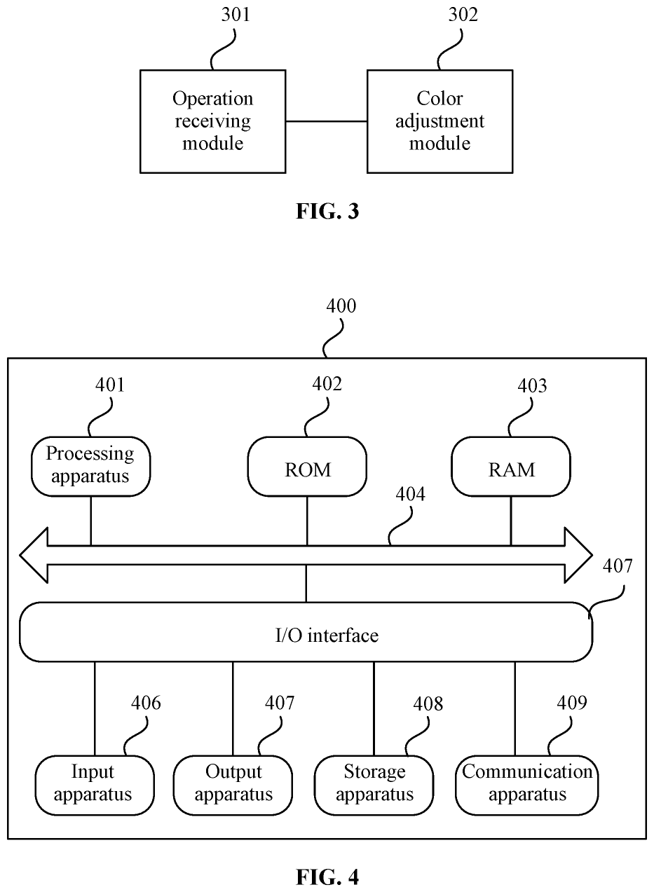

FIG. 3 is a structural block diagram of a beauty makeup special effect generation apparatus according to an embodiment of the present disclosure. The apparatus may be implemented in software and/or hardware, may be configured in an electronic device, may be typically configured in a mobile phone or a tablet computer, and may create a new special effect on the basis of an existing special effect by performing a beauty makeup special effect generation method. As shown in FIG. 3, the beauty makeup special effect generation apparatus provided in this embodiment may include an operation receiving module 301 and a color adjustment module 302.

The operation receiving module 301 is configured to receive a color adjustment operation for a first beauty makeup special effect.

The color adjustment module 302 is configured to determine, in response to the color adjustment operation, a target color corresponding to the color adjustment operation, and perform color adjustment on the first beauty makeup special effect according to the target color, to generate a second beauty makeup special effect.

The beauty makeup special effect generation apparatus according to this embodiment receives a color adjustment operation for a first beauty makeup special effect by the operation receiving module; and determines, in response to the color adjustment operation, a target color corresponding to the color adjustment operation and performs color adjustment on the first beauty makeup special effect by the color adjustment module according to the target color to generate a second beauty makeup special effect. According to this embodiment, by taking the above-described technical solution, the second beauty makeup special effect is obtained by the direct adjustment on the basis of the first beauty makeup special effect, and the beauty makeup special effect material does not need to be redrawn, so that the difficulty in creating the beauty makeup special effect can be lowered, the efficiency for creating the beauty makeup special effect can be improved, and the user experience can be improved.

In the above embodiment, the color adjustment module 302 may include a coefficient determination unit configured to determine a current adjustment coefficient corresponding to a current color component according to the target color for at least part of color components of at least part of pixels in the first beauty makeup special effect; and a color adjustment unit configured to adjust a color component value of the current color component by using the current adjustment coefficient and a current transparency coefficient of the first beauty makeup special effect.

In the above embodiment, the coefficient determination unit may include a first coefficient determination sub-unit configured to determine a first sub-adjustment coefficient corresponding to a current color component and a second sub-adjustment coefficient corresponding to the current pixel according to the target color; and a second coefficient determination sub-unit configured to calculate a current adjustment coefficient corresponding to the current color component on the basis of the first sub-adjustment coefficient and the second sub-adjustment coefficient.

In the above embodiment, the first coefficient determination sub-unit may be configured to determine a first sub-adjustment coefficient corresponding to the current color component according to a color component value of a corresponding color component, corresponding to the current color component, in the target color; and the second coefficient determination sub-unit may be configured to determine a second sub-adjustment coefficient corresponding to the current pixel according to a first grayscale value of a target pixel, corresponding to the current pixel, in a target grayscale image and a second grayscale value corresponding to the target color, for example, pixels in the target grayscale image correspond to pixels in the first beauty makeup special effect.

In the above embodiment, the first beauty makeup special effect may be a human image beauty makeup special effect, and the beauty makeup special effect generation apparatus according to this embodiment may further include a position adjustment module configured to adjust a position where the first beauty makeup special effect is added in a corresponding human image part in response to the position adjustment operation for the first beauty makeup special effect.

In the above embodiment, the position adjustment module may include a key point adjustment unit configured to adjust key points corresponding to the first beauty makeup special effect in a corresponding human image part; and a position determination unit configured to determine a position where the first beauty makeup special effect is added according to the key points adjusted.

In the above embodiment, the position adjustment operation may be a scaling coefficient adjustment operation, and the key point adjustment unit may be configured to scale a three-dimensional model corresponding to the first beauty makeup special effect according to a target scaling coefficient corresponding to the scaling coefficient adjustment operation, to adjust key points corresponding to the first beauty makeup special effect in the three-dimensional model, where the key points in the three-dimensional model correspond to the key points in the corresponding human image part.

The beauty makeup special effect generation apparatus according to the embodiment of the present disclosure can perform the beauty makeup special effect generation method according to any of the embodiments of the present disclosure, and has corresponding functional modules for executing the beauty makeup special effect generation method and corresponding beneficial effects obtained by executing the beauty makeup special effect generation method. For the technical details that are not described in detail in this embodiment, reference may be made to the beauty makeup special effect generation method according to any embodiment of the present disclosure.

Referring now to FIG. 4, FIG. 4 shows a schematic structural diagram of an electronic device (e.g., a terminal device) 400 applicable to implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a portable Android device (PAD), a portable media player (PMP), and a vehicle-mounted terminal (such as a vehicle-mounted navigation terminal) and a fixed terminal such as a digital television (TV) and a desktop computer. The electronic device shown in FIG. 4 is merely an example and should not be construed as limiting the functionality and scope of use of the embodiments of the present disclosure.

As shown in FIG. 4, the electronic device 400 may include a processing apparatus (e.g., a central processing unit, a graphics processing unit, or the like) 401, which may perform various appropriate actions and processes according to a program stored in a read-only memory (ROM) 402 or a program loaded from a storage apparatus 408 into a random access memory (RAM) 403. In RAM 403, various programs and data required by the electronic device 400 for operation are also stored. The processing apparatuses 401, ROM 402 and RAM 403 are connected to each other via a bus 404. An input/output (I/O) interface 405 is also connected to the bus 404.

Generally, the following apparatuses may be connected to the I/O interface 405: an input apparatus 406 including, for example, a touch screen, a touch pad, a keyboard, a mouse, a camera, a microphone, an accelerometer, a gyroscope, and the like; an output apparatus 407 including, for example, a liquid crystal display (LCD), a speaker, a vibrator, and the like; a storage apparatus 408 including, for example, a magnetic tape, a hard disk, and the like; and a communication apparatus 409. The communication apparatus 409 may allow the electronic device 400 to perform wireless or wired communicate with other devices to exchange data. Although FIG. 4 illustrates an electronic device 400 having various apparatuses, it should be understood that it is not required to have all of the apparatuses shown. Alternatively, more or fewer apparatuses may be implemented or presented.

Particularly, according to the embodiment of the present disclosure, the process described above with reference to the flowchart may be implemented as a computer software program. For example, the embodiments of the present disclosure include a computer program product. The computer program product includes a computer program carried in a non-transitory computer-readable medium. The computer program includes program codes for executing the method shown in the flowchart. In such an embodiment, the computer program may be downloaded and installed from the network through the communication device 409, or installed from the storage apparatus 408, or installed from the ROM 402. When the computer program is executed by the processing apparatus 401, the above functions defined in the method of the disclosed embodiment are performed.

It is to be noted that the preceding computer-readable medium in the present disclosure may be a computer-readable signal medium or a computer-readable storage medium or any combination thereof. The computer-readable storage medium, for example, may be, but is not limited to, an electronic, magnetic, optical, electromagnetic, infrared or semiconductor system, apparatus or device or any combination thereof. More specific examples of the computer-readable storage medium may include, but are not limited to, an electrical connection with one or more wires, a portable computer magnetic disk, a hard disk, a random-access memory (RAM), a read-only memory (ROM), an erasable programmable read-only memory (EPROM or a flash memory), an optical fiber, a portable compact disc read-only memory (CD-ROM), an optical memory device, a magnetic memory device, or any appropriate combination thereof. In the present disclosure, the computer-readable storage medium may be any tangible medium including or storing a program. The program may be used by or used in conjunction with an instruction execution system, apparatus, or device. In the present disclosure, the computer-readable signal medium may include a data signal on a baseband or propagated as a part of a carrier, and computer-readable program codes are carried in the data signal. The data signal propagated in this manner may be in multiple forms and includes, but is not limited to, an electromagnetic signal, an optical signal, or any suitable combination thereof. The computer-readable signal medium may further be any computer-readable medium other than the computer-readable storage medium. The computer-readable signal medium may send, propagate, or transmit a program used by or in conjunction with an instruction execution system, apparatus, or device. The program codes included on the computer-readable medium may be transmitted via any appropriate medium which includes, but is not limited to, a wire, an optical cable, a radio frequency (RF), or any appropriate combination thereof.

In some embodiments, clients and servers may communicate by using any currently known or future developed network protocols, such as the hyper text transfer protocol (HTTP), and may be interconnected with any form or medium of digital data communication (such as a communication network). Examples of the communication network include a local area network (LAN), a wide area networks (WAN), an internet (such as the Internet), and a peer-to-peer network (such as an Ad-Hoc network), as well as any currently known or future developed network.

The computer-readable medium may be included in the electronic device or may exist alone without being assembled into the electronic device.

The computer readable medium carries one or more programs that, when executed by the electronic device, cause the electronic device to: receive a color adjustment operation for a first beauty makeup special effect; determine a target color corresponding to the color adjustment operation in response to the color adjustment operation, and perform color adjustment on the first beauty makeup special effect according to the target color to generate a second beauty makeup special effect.

Computer program codes for performing the operations in the present disclosure may be written in one or more programming languages or combination thereof. The preceding one or more programming languages include, but are not limited to, object-oriented programming languages such as Java, Smalltalk and C++, as well as conventional procedural programming languages such as “C” language or similar programming languages. Program codes may be executed entirely on a user computer, partly on a user computer, as a stand-alone software package, partly on a user computer and partly on a remote computer, or entirely on a remote computer or a server. In the case relate to the remote computer, the remote computer may be connected to the user computer via any kind of network including a local area network (LAN) or a wide area network (WAN), or may be connected to an external computer (for example, via the internet through an internet service provider).

The flowcharts and block diagrams in the drawings show the possibly implemented architecture, function and operation of the system, method and computer program product according to various embodiments of the present disclosure. In this regard, each block in the flowcharts or block diagrams may represent a module, a program segment, or part of codes that contains one or more executable instructions for implementing specified logical functions. It is also to be noted that in some alternative implementations, the functions marked in the blocks may occur in an order different from those marked in the drawings. For example, two successive blocks may, in fact, be executed substantially in parallel or in a reverse order, which depends on the functions involved. It is also to be noted that each block in the block diagrams and/or flowcharts and a combination of blocks in the block diagrams and/or flowcharts may be implemented by a specific-purpose hardware-based system which performs specified functions or operations or a combination of specific-purpose hardware and computer instructions.

The units involved in the embodiments of the present disclosure may be implemented by software or hardware. In some cases, the name of the module does not constitute a limitation on the unit itself.

The functions described above herein may be executed, at least partially, by one or more hardware logic components. For example, and without limitations, example types of hardware logic components that may be used include: a field-programmable gate array (FPGA), an application-specific integrated circuit (ASIC), an application-specific standard product (ASSP), a system on a chip (SOC), a complex programmable logic device (CPLD) and the like.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any appropriate combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical storage device, a magnetic storage device, or any appropriate combination thereof.

According to one or more embodiments of the present disclosure, a beauty makeup special effect generation method is provided according to a first example, the beauty makeup special effect generation method includes:
receiving a color adjustment operation for a first beauty makeup special effect; and
in response to the color adjustment operation, determining a target color corresponding to the color adjustment operation, and performing color adjustment on the first beauty makeup special effect according to the target color, to generate a second beauty makeup special effect.

According to one or more embodiments of the present disclosure, in the method according to a second example on the basis of the first example, the performing color adjustment on the first beauty makeup special effect according to the target color includes:
determining a current adjustment coefficient corresponding to a current color component according to the target color for at least part of color components of at least part of pixels in the first beauty makeup special effect; and
adjusting a color component value of the current color component by using the current adjustment coefficient and a current transparency coefficient of the first beauty makeup special effect.

According to one or more embodiments of the present disclosure, in the method according to a third example on the basis of the second example, the determining a current adjustment coefficient corresponding to a current color component according to the target color includes:
determining, according to the target color, a first sub-adjustment coefficient corresponding to a current color component and a second sub-adjustment coefficient corresponding to the current pixel; and
calculating a current adjustment coefficient corresponding to the current color component on the basis of the first sub-adjustment coefficient and the second sub-adjustment coefficient.

According to one or more embodiments of the present disclosure, in the method according to a fourth example on the basis of the third example, the determining, according to the target color, a first sub-adjustment coefficient corresponding to a current color component and a second sub-adjustment coefficient corresponding to the current pixel includes:
determining a first sub-adjustment coefficient corresponding to a current color component according to a color component value of a corresponding color component of the target color; and
determining a second sub-adjustment coefficient corresponding to the current pixel according to a first grayscale value of a target pixel corresponding to the current pixel in a target grayscale image and a second grayscale value corresponding to the target color, where pixels in the target grayscale image correspond to pixels in the first beauty makeup special effect.

According to one or more embodiments of the present disclosure, in the method according to a fifth example on the basis of any one of the first example to the fourth example, the first beauty makeup special effect is a human image beauty makeup special effect, and the method further includes:
adjusting a position where the first beauty makeup special effect is added in a corresponding human image part in response to a position adjustment operation for the first beauty makeup special effect.

According to one or more embodiments of the present disclosure, in the method according to a sixth example on the basis of the fifth example, the adjusting a position where the first beauty makeup special effect is added in a corresponding human image part includes:
adjusting key points corresponding to the first beauty makeup special effect in a corresponding human image part; and
determining a position where the first beauty makeup special effect is added according to the key points adjusted.

According to one or more embodiments of the present disclosure, in the method according to a seventh example on the basis of the sixth example, the position adjustment operation is a scaling coefficient adjustment operation, and the adjusting key points corresponding to the first beauty makeup special effect in a corresponding human image part includes:
scaling a three-dimensional model corresponding to the first beauty makeup special effect according to a target scaling coefficient corresponding to the scaling coefficient adjustment operation, to adjust key points corresponding to the first beauty makeup special effect in the three-dimensional model, where the key points in the three-dimensional model correspond to the key points in the corresponding human image part.

According to one or more embodiments of the present disclosure, a beauty makeup special effect generation apparatus is provided according to an eighth example, which includes:
an operation receiving module configured to receive a color adjustment operation for a first beauty makeup special effect; and
a color adjustment module configured to, in response to the color adjustment operation, determine a target color corresponding to the color adjustment operation, and perform color adjustment on the first beauty makeup special effect according to the target color, to generate a second beauty makeup special effect.

According to one or more embodiments of the present disclosure, an electronic device is provided according to a ninth example, which includes: one or more processors, and a memory configured to store one or more programs.

The one or more programs, when executed by the one or more processors, cause the one or more processors to implement the beauty makeup special effect generation method according to any one of the first example to the seventh example.

According to one or more embodiments of the present disclosure, it is provided according to a tenth example a computer readable storage medium having stored therein a computer program. The computer program, when executed by a processor, implements the beauty makeup special effect generation method according to any one of the first example to the seventh example.

According to one or more embodiments of the present disclosure, it is provided according to an eleventh example a computer program product. The computer program product, when executed by a computer, causes the computer to implement the beauty makeup special effect generation method according to any one of the first example to the seventh example.

The preceding description is merely illustrative of preferred embodiments of the present disclosure and the technical principles used therein. The person of ordinary skill in the art should understand that the scope of disclosure involved in the disclosure is not limited to the technical solutions formed by the particular combination of the preceding technical features, but intended to cover other technical solutions which may be formed by any combination of the preceding technical features or their equivalents without departing from the concept of the disclosure. For example, the technical solutions formed by mutual substitutions of the preceding features and the technical features disclosed in the present disclosure (but not limited to) that have similar functions to the preceding features.

In addition, although the operations are depicted in a particular order, this should not be construed as requiring that such operations should be performed in the particular order shown or in a sequential order. In certain circumstances, multitasking and parallel processing may be advantageous. Similarly, although specific implementation details are included in the above discussion, these should not be construed as limiting the scope of the present disclosure. Some features described in the context of separate embodiments may also be implemented in combination in a single embodiment. Conversely, various features described in the context of a single embodiment may also be implemented in multiple embodiments, individually, or in any suitable sub-combination.

Although the subject matter is described in the language specific to structural features and/or methodological logic acts, it is to be understood that the subject matter defined in the appended claims is not necessarily limited to the specific features or acts described above. Conversely, the specific features and acts described above are merely example forms of implementing the claims.

What is claimed is:

1. A beauty makeup special effect generation method, comprising:
receiving a color adjustment operation for a first beauty makeup special effect; and
in response to the color adjustment operation, determining a target color corresponding to the color adjustment operation and performing color adjustment on the first beauty makeup special effect according to the target color to generate a second beauty makeup special effect.

2. The method according to claim 1, wherein the performing color adjustment on the first beauty makeup special effect according to the target color comprises:
for at least part of color components of at least part of pixels in the first beauty makeup special effect, determining a current adjustment coefficient corresponding to a current color component according to the target color; and
adjusting a color component value of the current color component by using the current adjustment coefficient and a current transparency coefficient of the first beauty makeup special effect.

3. The method according to claim 2, wherein the determining a current adjustment coefficient corresponding to a current color component according to the target color comprises:
determining, according to the target color, a first sub-adjustment coefficient corresponding to a current color component and a second sub-adjustment coefficient corresponding to the current pixel; and
calculating, on the basis of the first sub-adjustment coefficient and the second sub-adjustment coefficient, a current adjustment coefficient corresponding to the current color component.

4. The method according to claim 3, wherein the determining, according to the target color, a first sub-adjustment coefficient corresponding to a current color component and a second sub-adjustment coefficient corresponding to the current pixel comprises:
determining the first sub-adjustment coefficient corresponding to the current color component according to a color component value of a corresponding color component of the target color; and
determining the second sub-adjustment coefficient corresponding to the current pixel according to a first grayscale value of a target pixel corresponding to the current pixel in a target grayscale image and a second grayscale value corresponding to the target color, wherein pixels in the target grayscale image correspond to pixels in the first beauty makeup special effect.

5. The method according to claim 1, wherein the first beauty makeup special effect is a human image beauty makeup special effect, and the method further comprises:
adjusting a position where the first beauty makeup special effect is added in a corresponding human image part in response to a position adjustment operation for the first beauty makeup special effect.

6. The method according to claim 2, wherein the first beauty makeup special effect is a human image beauty makeup special effect, and the method further comprises:
adjusting a position where the first beauty makeup special effect is added in a corresponding human image part in response to a position adjustment operation for the first beauty makeup special effect.

7. The method according to claim 3, wherein the first beauty makeup special effect is a human image beauty makeup special effect, and the method further comprises:
adjusting a position where the first beauty makeup special effect is added in a corresponding human image part in response to a position adjustment operation for the first beauty makeup special effect.

8. The method according to claim 4, wherein the first beauty makeup special effect is a human image beauty makeup special effect, and the method further comprises:
adjusting a position where the first beauty makeup special effect is added in a corresponding human image part in response to a position adjustment operation for the first beauty makeup special effect.

9. The method according to claim 5, wherein the adjusting a position where the first beauty makeup special effect is added in a corresponding human image part comprises:
adjusting key points corresponding to the first beauty makeup special effect in a corresponding human image part; and
determining a position where the first beauty makeup special effect is to be moved according to the key points adjusted.

10. The method according to claim 9, wherein the position adjustment operation is a scaling coefficient adjustment operation, and the adjusting key points corresponding to the first beauty makeup special effect in a corresponding human image part comprises:
scaling, according to a target scaling coefficient corresponding to the scaling coefficient adjustment operation, a three-dimensional model corresponding to the first beauty makeup special effect to adjust key points corresponding to the first beauty makeup special effect in the three-dimensional model, wherein the key points in the three-dimensional model correspond to the key points in the corresponding human image part.

11. An electronic device, comprising:
one or more processors; and
a memory configured to store one or more programs,
wherein the one or more programs, when executed by the one or more processors, cause the one or more processors to implement the following steps:
receiving a color adjustment operation for a first beauty makeup special effect; and
in response to the color adjustment operation, determining a target color corresponding to the color adjustment operation and performing color adjustment on the first beauty makeup special effect according to the target color to generate a second beauty makeup special effect.

12. The device according to claim 11, wherein the performing color adjustment on the first beauty makeup special effect according to the target color comprises:
for at least part of color components of at least part of pixels in the first beauty makeup special effect, determining a current adjustment coefficient corresponding to a current color component according to the target color; and
adjusting a color component value of the current color component by using the current adjustment coefficient and a current transparency coefficient of the first beauty makeup special effect.

13. The device according to claim 12, wherein the determining a current adjustment coefficient corresponding to a current color component according to the target color comprises:
determining, according to the target color, a first sub-adjustment coefficient corresponding to a current color component and a second sub-adjustment coefficient corresponding to the current pixel; and
calculating, on the basis of the first sub-adjustment coefficient and the second sub-adjustment coefficient, a current adjustment coefficient corresponding to the current color component.

14. The device according to claim 13, wherein the determining, according to the target color, a first sub-adjustment coefficient corresponding to a current color component and a second sub-adjustment coefficient corresponding to the current pixel comprises:
determining the first sub-adjustment coefficient corresponding to the current color component according to a color component value of a corresponding color component of the target color; and
determining the second sub-adjustment coefficient corresponding to the current pixel according to a first grayscale value of a target pixel corresponding to the current pixel in a target grayscale image and a second grayscale value corresponding to the target color, wherein pixels in the target grayscale image correspond to pixels in the first beauty makeup special effect.

15. The device according to claim 11, wherein the first beauty makeup special effect is a human image beauty makeup special effect, and the one or more programs, when executed by the one or more processors, further cause the one or more processors to implement the following steps:
adjusting a position where the first beauty makeup special effect is added in a corresponding human image part in response to a position adjustment operation for the first beauty makeup special effect.

16. The device according to claim 12, wherein the first beauty makeup special effect is a human image beauty makeup special effect, and the one or more programs, when executed by the one or more processors, further cause the one or more processors to implement the following steps:
adjusting a position where the first beauty makeup special effect is added in a corresponding human image part in response to a position adjustment operation for the first beauty makeup special effect.

17. The device according to claim 13, wherein the first beauty makeup special effect is a human image beauty makeup special effect, and the one or more programs, when executed by the one or more processors, further cause the one or more processors to implement the following steps:
adjusting a position where the first beauty makeup special effect is added in a corresponding human image part in response to a position adjustment operation for the first beauty makeup special effect.

18. The device according to claim 15, wherein the adjusting a position where the first beauty makeup special effect is added in a corresponding human image part comprises:
adjusting key points corresponding to the first beauty makeup special effect in a corresponding human image part; and
determining a position where the first beauty makeup special effect is to be moved according to the key points adjusted.

19. The device according to claim 18, wherein the position adjustment operation is a scaling coefficient adjustment operation, and the adjusting key points corresponding to the first beauty makeup special effect in a corresponding human image part comprises:
scaling, according to a target scaling coefficient corresponding to the scaling coefficient adjustment operation, a three-dimensional model corresponding to the first beauty makeup special effect to adjust key points corresponding to the first beauty makeup special effect in the three-dimensional model, wherein the key points in the three-dimensional model correspond to the key points in the corresponding human image part.

20. A non-transitory computer-readable storage medium in which a computer program is stored, wherein the computer program, when executed by a processor, implements the following steps:
receiving a color adjustment operation for a first beauty makeup special effect; and
in response to the color adjustment operation, determining a target color corresponding to the color adjustment operation and performing color adjustment on the first beauty makeup special effect according to the target color to generate a second beauty makeup special effect.
